(19) United States
(12) Patent Application Publication
(10) Pub. No.: US 2009/0158949 A1
(43) Pub. Date: Jun. 25, 2009

(54) SCREEN PRINTING APPARATUS

(75) Inventor: Katsushi TAKEDA, Chuo-ku (JP)

Correspondence Address: SUGHRUE MION, PLLC, 2100 PENNSYLVANIA AVENUE, N.W., SUITE 800, WASHINGTON, DC, 20037, US

(73) Assignee: Elpida Memory, Inc., Tokyo (JP)

(21) Appl. No.: 12/337,073

(22) Filed: Dec. 17, 2008

(30) Foreign Application Priority Data
Dec. 19, 2007 (JP) 2007-327769

(51) Int. Cl. B41F 35/00

(52) U.S. Cl. 101/425

(57) ABSTRACT

A screen printing apparatus according to the present invention includes a frame member that holds a screen with a pattern hole formed therein, a substrate positioning section located below the frame member to position a substrate located opposite the screen, and a cleaning unit that simultaneously cleans a back surface of the screen and a front surface of the substrate. The cleaning unit includes a supply reel that supplies a cleaning sheet including a screen side cleaning surface used to clean the screen and a substrate side cleaning surface located opposite the screen side cleaning surface and used to clean the substrate.

### BACKGROUND OF THE INVENTION

This application is based upon and claims the benefit of priority from Japanese patent application No. 2007-327769, filed on Dec. 19, 2007, the disclosure of which is incorporated herein in its entirety by reference.

### FIELD OF THE INVENTION

The present invention relates to a screen printing apparatus including a screen cleaning unit that cleans a screen used for screen printing.

### DESCRIPTION OF THE RELATED ART

A screen printing apparatus disclosed in Japanese Patent Laid-Open No. H02-014145 and, relating to the present invention, positions a substrate by means of mechanical clamping or the like. However, the screen printing apparatus includes no mechanism to remove substrate dust resulting from possible contact of the substrate during the mechanical clamping, from a print surface of the substrate. Thus, the substrate dust needs to be removed manually or by using a separate, external cleaning device.

On the other hand, a screen printing apparatus including a screen cleaning unit has been disclosed (for example, Japanese Patent Laid-Open No. 2003-170570 or No. 2006-7462).

An operation of a screen cleaning unit according to a technique relating to the present invention will be described with reference to FIG. 1. FIG. 1 is a schematic diagram of a printing section and a screen cleaning unit in the screen printing apparatus according to the technique relating to the present invention.

Frame member 105a holds screen 105. Solder paste 107 is printed on substrate 110 by sliding squeegee 106 on screen 105. After solder paste 107 is printed on substrate 110, substrate positioning section 109 with substrate 110 mounted thereon is lowered from a position where substrate positioning section 109 keeps substrate 110 in contact with a bottom surface of screen 105.

Screen cleaning unit 102 includes supply reel 111a, head unit 113, and retrieval reel 111b. Supply reel 111a supplies cleaning sheet 111. Head unit 113 cleans screen 105. Retrieval reel 111b retrieves cleaning sheet 111 after cleaning. Screen cleaning unit 102 can be reciprocated between screen 105 and substrate 110 as shown by arrow A.

Head unit 113 includes suction nozzle 120 and two guide pieces 115a and 115b, and solvent shower nozzle 112. Solvent shower nozzle 112 supplies a solvent to cleaning sheet 111.

Retrieval reel 111b is rotationally driven by a driving motor (not shown in the drawings) to wind a roll of cleaning sheet 111 around supply reel 111a. Cleaning sheet 111 is made up of a material that is effective for wiping the back surface of screen 105.

Solvent shower nozzle 112 drops, onto cleaning sheet 111, a washing solvent fed from a solvent tank (not shown in the drawings) in which the washing solvent is stored.

Now, a feeding path for cleaning sheet 111 in screen cleaning unit 102 will be described.

Retrieval reel 111b is rotationally driven to draw out cleaning sheet 111 from supply reel 111a. Cleaning sheet 111 is then fed to head unit 113a. Cleaning sheet 111 is passed around guide piece 115a of head unit 113a and guided to suction nozzle 120a. Cleaning sheet 111 passes over suction nozzle 120a and is subsequently passed around guide piece 11 5b. Cleaning sheet 111 is then guided to retrieval reel 111b and wound around retrieval reel 111b.

Now, a method of cleaning screen 105 using screen cleaning unit 102 will be described.

First, substrate positioning section 109 with printed substrate 110 is lowered.

Then, solvent shower nozzle 112 drops, onto cleaning sheet 111, the washing solvent fed from the solvent tank (not shown in the drawings) in which the washing solvent is stored.

Thereafter, screen cleaning unit 102 is moved toward a conveying section (an unloader; not shown in the drawings), that is, rightward in the figure. Screen cleaning unit 102 then performs an operation of wiping the back surface of screen 105 while allowing suction nozzle 120a to perform a suction operation.

Subsequently, screen cleaning unit 102 is turned around and moved toward the conveying section (loader), that is, leftward in the figure. At this time, screen cleaning unit 102 feeds cleaning sheet 111 with the back surface thereof wiped, toward retrieval reel 111b. Screen cleaning unit 102 wipes the back surface of screen 105 using clean cleaning sheet 111, while allowing suction nozzle 120a to perform the suction operation.

The screen printing apparatus according to the technique relating to the present invention, shown in FIG. 1, cleans only the back surface of the screen and not the substrate. However, when printing is performed with foreign matter attached to the substrate, in particular, with very small printed matter, the resulting products may be defective. Thus, for cleaning, the print surface of the substrate conventionally needs to be wiped manually or by using a separate, external cleaning device.

However, according to the method in which an operator manually wipes the relevant portions, the apparatus needs to be stopped for cleaning. This reduces manufacturing efficiency. On the other hand, the method of using the separate, external cleaning device requires increased costs for the apparatus.

Furthermore, the cleaning device in the screen printing apparatus according to the technique relating to the present invention uses only one surface of the cleaning sheet. This also increases costs required for cleaning.

### SUMMARY

The present invention seeks to solve one or more of the above problems, or to improve upon those problems at least in part.

In one embodiment, there is provided a screen printing apparatus that includes holding means for holding a screen with a pattern hole formed therein, substrate positioning means for positioning a substrate located opposite the screen, the substrate positioning means being located below the holding means, and a cleaning unit simultaneously cleaning the back surface of the screen and the front surface of the substrate, wherein the cleaning unit includes supply means for supplying a cleaning sheet including a first surface used to clean the screen and a second surface located opposite the first surface and used to clean the substrate.

In the above, it is ensure stable printing characteristics while inhibiting a possible decrease in manufacturing efficiency and a possible increase in costs.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a diagram showing a configuration of a cleaning unit in a screen printing apparatus according to a technique relating to the present invention;

FIG. 2A is a plan view of an example of a screen printing apparatus according to the present invention;

FIG. 2B is a side view of an example of the screen printing apparatus according to the present invention;

FIG. 3 is a diagram showing a configuration of a cleaning unit in the screen printing apparatus according to the present invention; and

FIG. 4 is a schematic perspective diagram of a roll of a cleaning sheet used for the cleaning unit according to the present invention.

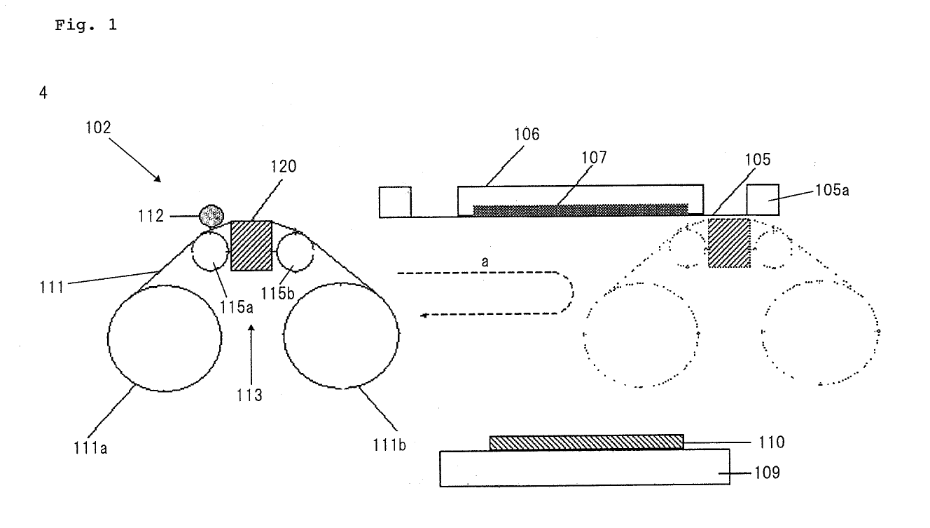

### DETAILED DESCRIPTION OF THE EXEMPLARY EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

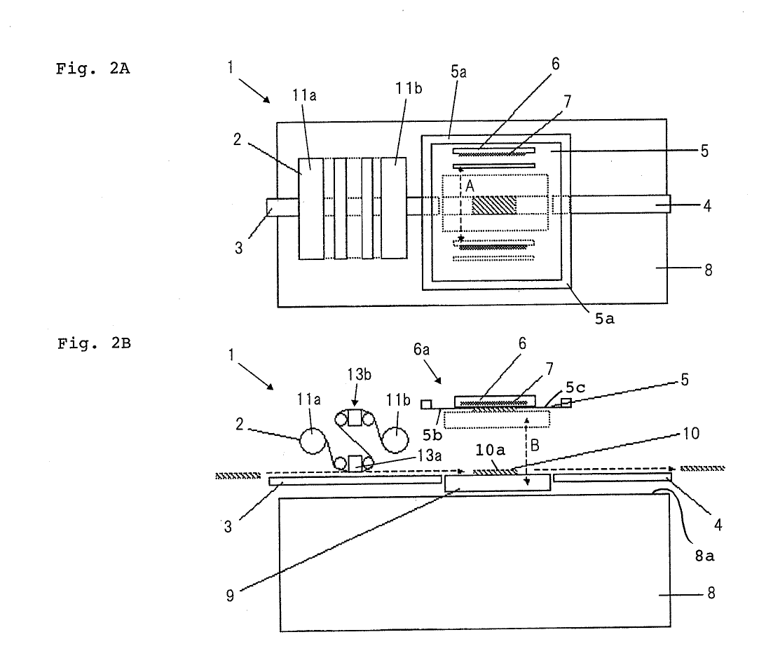

FIGS. 2A and 2B generally show a screen printing apparatus according to the exemplary embodiment. FIG. 2A is a plan view of the screen printing apparatus. FIG. 2B is a side view of the screen printing apparatus.

Screen printing apparatus 1 performs solder printing on substrate 10. Screen printing apparatus 1 includes table 8, conveying section (loader) 3, printing section 6a, conveying section (unloader) 4, and cleaning unit 2. Conveying section (unloader) 4 retrieves printed substrate 10. Cleaning unit 2 cleans back surface 5b of screen 5 and front surface 10a of substrate 10.

Conveying section 3 conveys substrate 10 to substrate positioning section 9.

Printing section 6a includes holding frame 5a that holds screen 5 with a pattern hole formed therein, squeegee 6, and substrate positioning section 9. Printing section 6a performs solder printing on substrate 10. Screen 5 is entirely circumferentially held by frame member 5a. Squeegee 6 is located on front surface 5c side of screen 5. Squeegee 6 is allowed to scan front surface 5c of screen 5 to spread solder paste 7 in the direction of arrow A. Substrate positioning section 9 is loaded below screen 5 and is movable in a direction perpendicular to top surface 8a of table 8 (in the direction of arrow B in FIG. 2B). Substrate positioning section 9 is mounted so as to place substrate 10 opposite screen 5. That is, in printing section 6a, screen 5 and substrate 10 are arranged such that back surface 5b of screen 5 and front surface 10a of substrate 10 lie opposite each other. Substrate positioning section 9 with substrate 10 mounted thereon is raised before printing is performed, and is lowered before being cleaned and before printed substrate 10 is retrieved.

Conveying section 4 retrieves and conveys printed substrate 10 to an apparatus (not shown in the drawings) which carries out the next step.

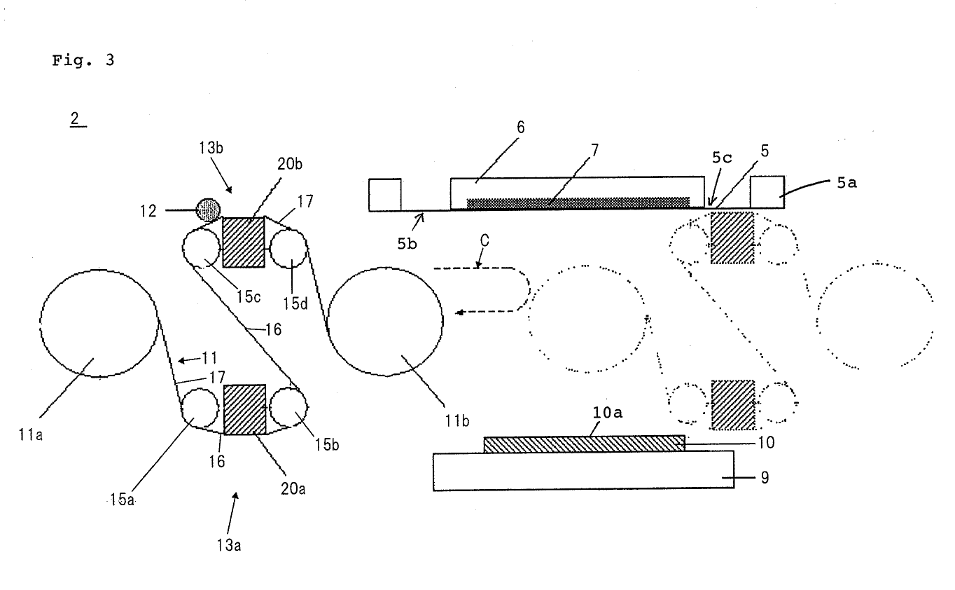

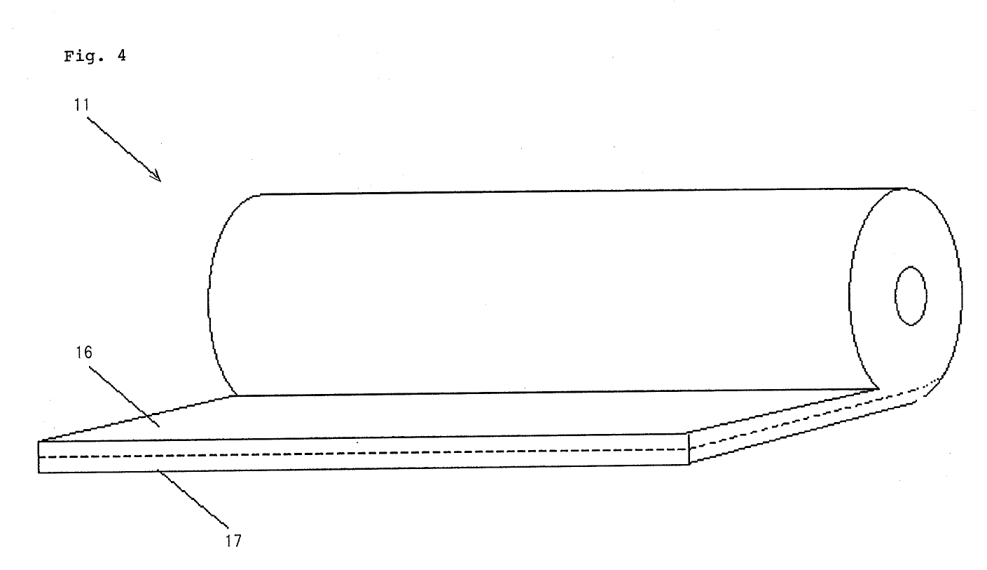

Now, a cleaning unit and a cleaning sheet will be described with reference to FIGS. 3 and 4.

FIG. 3 shows the configuration of the cleaning unit according to the exemplary embodiment in detail. FIG. 4 shows a schematic perspective diagram of a roll of the cleaning sheet.

Cleaning unit 2 includes supply reel 11a, substrate head unit 13a, screen head unit 13b, and retrieval reel 11b. Supply reel 11a supplies cleaning sheet 11 to substrate head unit 13a and screen head unit 13b. Substrate head unit 13a cleans substrate 10 using supplied cleaning sheet 11. That is, substrate head unit 13a slides substrate side cleaning surface (second surface) 16 of cleaning sheet 11 in abutment with front surface 10a of substrate 10. Screen head unit 13b cleans screen 5 using supplied cleaning sheet 11. That is, screen head unit 13b cleans screen 5 by sliding screen side cleaning surface (first surface) 17 in abutment with back surface 5b of screen 5. Retrieval reel 11b retrieves cleaning sheet 11 after cleaning.

Cleaning unit 2 can be reciprocated between screen 5 and substrate 10 as shown by arrow C in FIG. 3. During the reciprocation, cleaning unit 2 simultaneously cleans screen 5 and substrate 10. This cleaning method will be described below in detail.

Supply reel 11a and retrieval reel 11b are arranged at a predetermined distance from each other. Substrate head unit 13a and screen head unit 13b are arranged between supply reel 11a and retrieval reel 11b. Screen head unit 13b is located above substrate head unit 13a. Furthermore, screen head unit 13b is located above supply reel 11a and retrieval reel 11b because of the need to abut against screen 5 for cleaning. Substrate head unit 13a also needs to abut against substrate 10 for cleaning and is thus located below supply reel 11a and retrieval reel 11b.

Cleaning sheet 11 is wound and held around supply reel 11a in roll form. Retrieval reel 11b is rotationally driven by a driving motor (not shown in the drawings) to unwind cleaning sheet 11 wound around supply reel 11a.

As shown in FIG. 4, cleaning sheet 11 includes substrate side cleaning surface (second surface) 16 and a screen side cleaning surface (first surface) 17 located opposite substrate side cleaning surface 16. Both surfaces can be used for cleaning. Substrate side cleaning surface 16 is made up of a material that is effective for removing foreign matter from front surface 10a of substrate 10. Screen side cleaning surface 17 is made up of a material that is effective for wiping back surface 5b of screen 5. In particular, a preferred material for cleaning sheet 11 causes no dust and prevents wiped foreign matter from adhering to the cleaning surface again.

Substrate head unit 13a includes suction nozzle 20a for a suction operation, and two guide pieces 15a and 15b arranged on opposite sides of suction nozzle 20a. Like substrate head unit 13a, screen head unit 13b includes suction nozzle 20b and two guide pieces 15c and 15d. Screen head unit 13b further includes solvent shower nozzle 12 that supplies a solvent to cleaning sheet 11.

A suction port is formed in each of suction nozzles 20a and 20b, which are connected to suction means such as a suction pump or a blower (not shown in the drawings). The suction port in suction nozzle 20a is open toward substrate 10. The suction port in suction nozzle 20b is open toward screen 5.

Guide pieces 15a to 15d, which guide cleaning sheet 11, may be fixed or may be tensed by a spring or the like. If guide pieces 15a to 15d are tensed by the spring or the like, a wiping pressure may be varied depending on foreign matter attached to screen 5 or substrate 10.

Solvent shower nozzle 12 is supplied with a cleaning solvent such as ethanol or isopropanol from a solvent tank (not shown in the drawings) in which the solvent is stored. Solvent shower nozzle 12 is caused to eject the solvent by driving a pump (not shown in the drawings) that allows the solvent to be ejected.

Now, the feeding path for cleaning sheet 11 in cleaning unit 2 will be described. Cleaning sheet 11 fed from supply reel 11a is retrieved onto retrieval reel 11b via substrate head unit 13a and screen head unit 13b.

The feeding path for cleaning sheet 11 will be described below in further detail.

Cleaning sheet 11 is set on supply reel 11a so that substrate side cleaning surface 16 of cleaning sheet 11 corresponds to an inner surface side. Retrieval reel 11b is rotationally driven to feed cleaning sheet 11 drawn out from supply reel 11a, first, toward substrate head unit 13a. Cleaning sheet 11 is passed around guide piece 15a of substrate head unit 13a and guided to suction nozzle 20a in such a manner that screen side cleaning surface 17 faces guide piece 15a of substrate head unit 13a. At the position of the suction port in suction nozzle 20a, substrate side cleaning surface 16 of cleaning sheet 11 faces outward, that is, lies opposite substrate 10.

Cleaning sheet 11 having passed over suction nozzle 20a is passed around guide piece 15b and guided toward screen head unit 13b. Cleaning sheet 11 is subsequently passed around guide piece 15c so that substrate side cleaning surface 16 faces guide piece 15c, and is guided to suction nozzle 20b. At the position of the suction port in suction nozzle 20b, screen side cleaning surface 17 of cleaning sheet 11 faces outward, that is, lies opposite screen 5.

Cleaning sheet 11 having passed over suction nozzle 20b is passed around guide piece 15d and guided to retrieval reel 11b. Cleaning sheet 11 is then wound around and retrieved onto retrieval reel 11b.

Now, a method of cleaning screen 5 and substrate 10 using cleaning unit 2 will be described.

First, substrate positioning section 9 with printed substrate 10 mounted thereon is lowered.

Then, the solvent is dropped from solvent shower nozzle 12 onto cleaning sheet 11, which is thus impregnated with the solvent. Then, a predetermined amount of cleaning sheet 11 is wound such that a portion of cleaning sheet 11 impregnated with the solvent reaches the position of the suction port in suction nozzle 20b.

Then, screen printing apparatus 1 allows suction nozzles 20a and 20b to perform a suction operation. Furthermore, screen printing apparatus 1 brings substrate side cleaning surface 16 of cleaning sheet 11 into contact with front surface 10a of substrate 10, while bringing screen side cleaning surface 17 into contact with back surface 5b of screen 5. In this condition, screen printing apparatus 1 moves cleaning unit 2 toward conveying section 4.

Solder paste 7 attached to front surface 5c side of screen 5 is sucked toward back surface 5b of screen 5 by the suction operation of suction nozzle 20b. Solder paste 7 sucked down to back surface 5b side of screen 5 is dissolved and wiped by screen side cleaning surface 17 impregnated with the solvent. Thus, screen 5 is cleaned. Simultaneously with cleaning of screen 5, substrate 10 is cleaned. Substrate dust and the like on front surface 10a of substrate 10 are removed by the suction operation of suction nozzle 20a. Moreover, substrate side cleaning surface 16 wipes off dirt or the like on front surface 10a of substrate 10.

Subsequently, when cleaning unit 2 turns around and moves from conveying section 4 toward conveying section 3, first, cleaning sheet 11 with which back surface 5b of screen 5 and front surface 10a of substrate 10 have been wiped is fed toward retrieval reel 11b. That is, the unused surface of cleaning sheet 11 is positioned at the suction ports of suction nozzles 20a and 20b.

In this condition, while allowing suction nozzles 20a and 20b to perform the suction operation, cleaning unit 2 is turned around and moved from conveying section 4 toward conveying section 3. Thus, the clean surface of cleaning sheet 11 is used to remove the solvent and solder paste 7 remaining on back surface 5b of screen 5 and the substrate dust and dirt remaining on front surface 10a of substrate 10.

Furthermore, in the exemplary embodiment, screen side cleaning surface 17 of cleaning sheet 11 is used to clean back surface 5b of screen 5 but not to clean substrate 10. Thus, the exemplary embodiment prevents the cleaning of screen 5 from contaminating substrate 10 with solder paste 7 attached to screen side cleaning surface 17.

As described above, cleaning unit 2 of the screen printing apparatus according to the exemplary embodiment can clean not only back surface 5b of screen 5 but also front surface 10a of substrate 10 immediately before the subsequent printing step. If substrate 10 is manually cleaned, a printing operation by the screen printing apparatus needs to be temporarily halted before the cleaning operation can be started. However, the exemplary embodiment allows the substrate to be cleaned during the printing step. This prevents the cleaning of substrate 10 from reducing manufacturing efficiency.

Furthermore, cleaning unit 2 of the screen printing apparatus according to the exemplary embodiment uses both surfaces of cleaning sheet 11. Thus, cleaning sheet 11 can be effectively utilized, allowing the high quality of products to be maintained at low running costs.

While the exemplary embodiments of the present invention have been described using specific terms, such description is for illustrative purposes only, and it is to be understood that changes and variations may be made without departing from the spirit or scope of the following claims.

What is claimed is:

1. A screen printing apparatus comprising:
holding means for holding a screen with a pattern hole formed therein;
substrate positioning means for positioning a substrate located opposite the screen, the substrate positioning means being located below the holding means; and
a cleaning unit simultaneously cleaning a back surface of the screen and a front surface of the substrate,
wherein the cleaning unit includes supply means for supplying a cleaning sheet including a first surface used to clean the screen and a second surface located opposite the first surface and used to clean the substrate.

2. The screen printing apparatus according to claim 1, further comprising solvent supply means for supplying the first surface of the cleaning sheet with a solvent that dissolves solder paste attached to the back surface of the screen.

3. The screen printing apparatus according to claim 1, wherein the cleaning unit comprises retrieval means for retrieving the cleaning sheet supplied by the supply means and used for the cleaning.

4. The screen printing apparatus according to claim 1, wherein the cleaning unit reciprocates between the holding means and the substrate positioning means while sliding the first surface of the cleaning sheet on the back surface of the screen and at the same time sliding the second surface of the cleaning sheet on the front surface of the substrate.

5. The screen printing apparatus according to claim 1, wherein the cleaning unit includes a screen head that allows the first surface of the cleaning sheet to abut against the back surface of the screen and a substrate head that allows the second surface of the cleaning sheet to abut against the front surface of the substrate.

6. The screen printing apparatus according to claim 5, further comprising retrieval means for retrieving the cleaning sheet supplied by the supply means and used for the cleaning, and the retrieval means retrieves the cleaning sheet after the cleaning sheet has passed over the substrate head and the screen head.

7. The screen printing apparatus according to claim 5, wherein a suction port is formed in the screen head opposite the back surface of the screen, and a suction port is formed in the substrate head opposite the front surface of the substrate.

8. A screen printing apparatus comprising:
a frame member that holds a screen with a pattern hole formed therein;
a substrate positioning section that positions a substrate located opposite the screen, the substrate positioning section being located below the frame member; and
a cleaning unit that simultaneously cleans a back surface of the screen and a front surface of the substrate and includes supply reel that supplies a cleaning sheet including a first surface used to clean the screen and a second surface located opposite the first surface and used to clean the substrate.

9. The screen printing apparatus according to claim 8, further comprising solvent shower nozzle that supplies the first surface of the cleaning sheet with a solvent that dissolves solder paste attached to the back surface of the screen.

10. The screen printing apparatus according to claim 8, wherein the cleaning unit comprises retrieval reel that retrieves the cleaning sheet supplied by the supply reel and used for the cleaning.

11. The screen printing apparatus according to claim 8, wherein the cleaning unit reciprocates between the frame member and the substrate positioning section while sliding the first surface of the cleaning sheet on the back surface of the screen and at the same time sliding the second surface of the cleaning sheet on the front surface of the substrate.

12. The screen printing apparatus according to claim 8, wherein the cleaning unit includes a screen head that allows the first surface of the cleaning sheet to abut against the back surface of the screen and a substrate head that allows the second surface of the cleaning sheet to abut against the front surface of the substrate.

13. The screen printing apparatus according to claim 12, further comprising retrieval reel that retrieves the cleaning sheet supplied by the supply reel and used for the cleaning, and the retrieval reel retrieves the cleaning sheet after the cleaning sheet has passed over the substrate head and the screen head.

14. The screen printing apparatus according to claim 12, wherein a suction port is formed in the screen head opposite the back surface of the screen, and a suction port is formed in the substrate head opposite the front surface of the substrate.
